(19) United States
(12) Patent Application Publication
(10) Pub. No.: US 2014/0009462 A1
(43) Pub. Date: Jan. 9, 2014

(54) SYSTEMS AND METHODS FOR IMPROVING OVERALL QUALITY OF THREE-DIMENSIONAL CONTENT BY ALTERING PARALLAX BUDGET OR COMPENSATING FOR MOVING OBJECTS

(71) Applicant: 3DMedia Corporation, Research Triangle Park, NC (US)

(72) Inventors: Michael McNamer, Apex, NC (US); Tassos Markas, Chapel Hill, NC (US); Daniel Searles, Durham, NC (US)

(21) Appl. No.: 13/865,127

(22) Filed: Apr. 17, 2013

Related U.S. Application Data
(60) Provisional application No. 61/625,652, filed on Apr. 17, 2012.

(51) Int. Cl. G06T 19/20

(52) U.S. Cl. CPC G06T 19/20
USPC 345/419

(57) ABSTRACT

Systems and methods for improving overall quality of three-dimensional (3D) content by altering parallax budget and compensating for moving objects are disclosed. According to an aspect, a method includes identifying areas including one or more pixels of the 3D image that violate pre-defined disparity criterion. Further, the method includes identifying a region that includes pixels whose disparity exceeds a predetermined threshold. The method also includes identifying pixels belonging to either left or right images to replace the corresponding ones on the other image. Further, the method includes identifying key pixels to determine disparity attributes of a problem area. The method also includes identifying a proper depth of key pixels. Further, the method includes calculating the disparity of all remaining pixels in the area based on the disparity values of key pixels.

### CROSS REFERENCE TO RELATED APPLICATION

This application claims the benefit of U.S. Patent Application No. 61/625,652, filed Apr. 17, 2012, the disclosure of which is incorporated herein by reference in its entirety.

### TECHNICAL FIELD

The subject matter disclosed herein relates to image processing. More particularly, the subject matter disclosed herein relates to systems and methods for improving overall quality of three-dimensional (3D) content by altering parallax budget and compensating for moving objects.

### BACKGROUND

A stereoscopic or 3D image consists of a pair of left and a right image that present two different views of an object or a scene. When each one of those images is presented to the corresponding human eye using a suitable display device, our brain forms a three-dimensional (3D) illusion and this is the way we can see the object or scene in three dimensions. A stereoscopic image pair can be created by utilizing two sensors with a slightly different offset that take a picture of a subject or a scene simultaneously, or by using a single sensor and take two pictures side-by-side but at different times. There are several 3D-enabled cameras in the market today that are basically 2D cameras with software that guide users how to take two pictures side-by-side and create a 3D pair. Also, 3D content can be created using standard camera with no hardware or software modifications by again taking two pictures side-by-side. Methods for creating 3D images using two pictures taken side-by-side can be found in U.S. patent application publication numbers 2010/043022 and 2010/043023. Although, such products present great value to the consumers since they can use existing camera platforms to create 3D content, a problem is that since the two pictures are taken at different timeframes, there is a possibility that objects in the scene may move between the times the two different pictures were captured. Typical problems arising from this 3D capturing method may include moving people, animals, and vehicles, reflections, as well as leaves of trees and water during windy conditions. This will result in a 3D image that is very difficult to see and can cause strain and eye fatigue. In addition, during this two-picture shooting technique, it is possible that the created 3D image will not have the correct parameters which will also result into a non-optimal composition and may also cause eye fatigue. For at least these reasons, systems and methods are needed for providing improved overall quality of 3D content.

### SUMMARY

The subject matter disclosed herein provides editing methods applied to 3D content to eliminate improper attributes that may cause viewing discomfort and to improve their overall quality. Editing methods disclosed herein provide detection and compensation for moving objects between the left and right images of a stereoscopic pair. In addition, methods disclosed herein can adjust various image characteristics, such as parallax budget, to create a stereoscopic pair that is more comfortable to view based on user preferences.

The presently disclosed subject matter can provide a comprehensive methodology that allows for both fully manual compensation, manually-assisted auto compensation, and fully automatic. In addition, the present disclosure can be applied to various methods of capturing images to create a stereoscopic image.

According to an aspect, moving object compensation between the two images can be identified by either using visual or automated means. A user looking at a 3D image can recognize areas of discomfort and can identify specific locations that need to be corrected. In addition, feedback can be provided to the user where such problem areas exist in an automated way. Once such problems have been identified, compensation can be achieved by copying an appropriate set of pixels from one image to the other image (i.e., target image) or vice versa. During the copying process, pixels belonging to the moving object need to be copied at the proper location to accommodate for the proper depth of the moving object. The identification of the proper location can be completed using manual assisted process or a fully automated one. The same process can repeat for all moving objects in a scene to create a 3D image with optimized viewing experience. Once the moving object compensation process has been completed, images can be adjusted to optimize for color, exposure, and white-balancing. Also, other 3D parameters can be adjusted to optimize for 3D experience. Those parameters include the perceived distance of the closest and the furthest objects in the image, as well as the total parallax budget. Finally, a 3D image can be cropped and the order of left and right images can be reversed to accommodate for different display characteristics.

### BRIEF DESCRIPTION OF THE DRAWINGS

The foregoing summary, as well as the following detailed description of various embodiments, is better understood when read in conjunction with the appended drawings. For the purposes of illustration, there is shown in the drawings exemplary embodiments; however, the invention is not limited to the specific methods and instrumentalities disclosed. In the drawings:

FIG. 1 is a block diagram of an exemplary image capture system including a primary image capture device and an auxiliary image capture device for use in capturing images of a scene and performing image processing according to embodiments of the presently disclosed subject matter;

FIG. 2 is a three-dimensional image containing moving objects between the its left and right components;

FIG. 3 shows diagrams depicting another example of a situation that can present difficulties with 3D image generation;

FIG. 4 is a flow chart of an example method for three-dimensional editing in accordance with embodiments of the present disclosure;

FIG. 5 is a flow chart of an example method for correcting problems identified in a 3D image in accordance with embodiments of the present disclosure;

FIG. 6 is a flow chart of an example method for automatically correcting problems identified attributed to moving objects or other three-dimensional viewing violations in accordance with embodiments of the present disclosure;

FIG. 7 is a flow chart of an example method for dense disparity estimation in accordance with embodiments of the present disclosure;

FIG. 8 is a flow chart of an example method for dense seeding in accordance with embodiments of the present disclosure;

FIG. 9 is a flow chart of an example method for disparity estimation in accordance with embodiments of the present disclosure;

FIG. 10 is a technique for correcting an area using a rectangular shape in accordance with embodiments of the present disclosure;

FIG. 11 is a technique for correcting an area using an arbitrary shape in accordance with embodiments of the present disclosure;

FIG. 12 is an exemplary method for calculating the outlines of an area using multiple control points;

FIG. 13 is an exemplary method for calculating the outlines of an area using a control point; and

FIG. 14 is an exemplary method for defining a boundary of an object.

### DETAILED DESCRIPTION

The subject matter of the present invention is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

While the embodiments have been described in connection with the preferred embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

It should be also noted that although techniques and processes described in this disclosure are applied to still images, the same processes and techniques can be also applied to video sequences. In this case, the results obtained by applying one of those techniques to one frame can be used for the subsequent frames as is, or can be used as starting points for improving the quality of the subsequent frames in the video sequence. It is noted that when there is significant change on a captured scene, methods disclosed herein can be re-applied to frame pair.

Any suitable technique can be used to create stereoscopic images. For example, a two camera system may be utilized. In another example, a single camera system can capture two images side-by-side. In yet another example, a single camera system can capture a single image, and perform conversion from 2D to 3D to create a stereoscopic image.

In a two camera system, each camera or image capture device may include an imager and a lens. The two cameras may be positioned in fixed locations, and the cameras may simultaneously or nearly simultaneously capture two images of the same scene.

In a single camera capture system, the methods utilized to create a stereoscopic image are different but methods and systems disclosed herein can be applied to such systems as well. During the 2D-to-3D conversion methods, typically applied in those systems, the principles of identifying segments, and the principles of moving segments and/or pixels to different positions to create depth are subjects that are presented within the present disclosure as well.

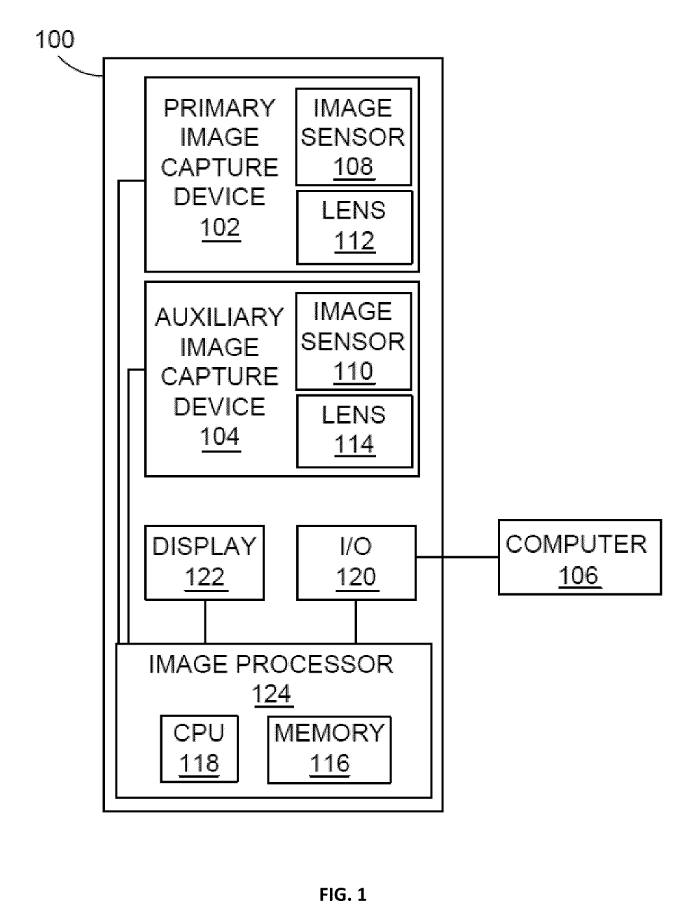

FIG. 1 illustrates a block diagram of an exemplary image capture system 100 including a primary image capture device 102 and an auxiliary image capture device 104 for use in capturing images of a scene and performing image processing according to embodiments of the presently disclosed subject matter. In this example, the system 100 is a digital camera capable of capturing multiple consecutive, still digital images of a scene. The devices 102 and 104 may each capture multiple consecutive still digital image of the scene. In another example, the system 100 may be a video camera capable of capturing a video sequence including multiple still images of a scene. In this example, the devices 102 and 104 may each capture a video sequence including multiple still images of the scene. A user of the system 100 may position the system in different positions for capturing images of different perspective views of a scene. The captured images may be suitably stored and processed for generating 3D images as described herein. For example, subsequent to capturing the images of the different perspective views of the scene, the system 100, alone or in combination with a computer such as computer 106, may use the images for generating a 3D image of the scene and for displaying the three-dimensional image to the user.

Referring to FIG. 1, the primary and auxiliary image capture devices 102 and 104 may include image sensors 108 and 110, respectively. The image sensor 110 may be of a lesser quality than the image sensor 108. Alternatively, the image sensor 110 may be of the same or greater quality as the image sensor 108. For example, the quality characteristics of images captured by use of the image sensor 110 may be of lower quality than the quality characteristics of images captured by use of the image sensor 108. The image sensors 108 and 110 may each include an array of charge coupled device (CCD) or CMOS sensors. The image sensors 108 and 110 may be exposed to a scene through lenses 112 and 114, respectively, and a respective exposure control mechanism. The lens 114 may be of lesser quality that the lens 112. The system 100 may also include analog and digital circuitry such as, but not limited to, a memory 116 for storing program instruction sequences that control the system 100, together with at least one CPU 118, in accordance with embodiments of the presently disclosed subject matter. The CPU 118 executes the program instruction sequences so as to cause the system 100 to expose the image sensors 108 and 110 to a scene and derive digital images corresponding to the scene. The digital image may be captured and stored in the memory 116. All or a portion of the memory 116 may be removable, so as to facilitate transfer of the digital image to other devices such as the computer 106. Further, the system 100 may be provided with an input/output (I/O) interface 120 so as to facilitate transfer of digital image even if the memory 116 is not removable. The system 100 may also include a display 122 controllable by the CPU 118 and operable to display the captured images in real-time for real-time viewing by a user.

The memory 116 and the CPU 118 may be operable together to implement an image processor 124 for performing image processing including generation of three-dimensional images in accordance with embodiments of the presently disclosed subject matter. The image processor 124 may control the primary image capture device 102 and the auxiliary image capture device 104 for capturing images of a scene. Further, the image processor 124 may further process the images and generate three-dimensional images as described herein.

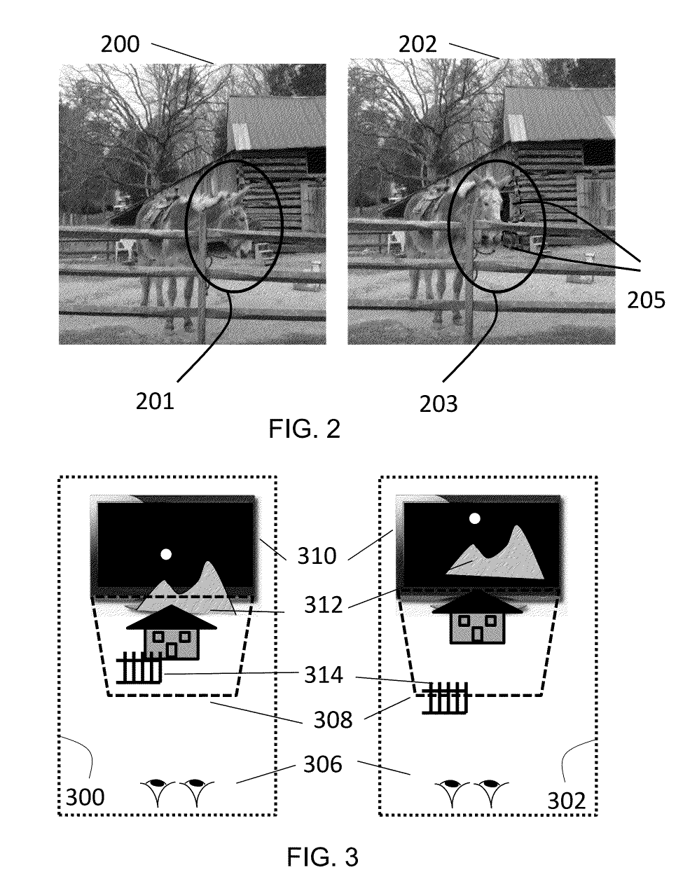

As described herein, a single camera, side-by-side approach to capturing images and generating a 3D image can introduce problems related to time of the capture of the two images. As an example, FIG. 2 illustrates a three-dimensional image containing moving objects between the its left and right components. Referring to FIG. 2, image 200 shows a left image captured by a camera, and image 202 shows a right image captured by the camera. The left image 200 shows an animal's head in an orientation 201, whereas the right image 202 shows the animal's head in a different orientation 203. Movement of the animal's head in this way will not generate a proper 3D image by simply utilizing the left 200 and right 202 images as is. This limitation is addressed by the presently disclosed subject matter. Movement of other objects between the capture of different images can cause similar problems, which are addressed by the presently disclosed subject matter.

FIG. 3 shows diagrams depicting another example of a situation that can present limitations with 3D image generation. Referring to FIG. 3, a three-dimensional image is projected from a three-dimensional display 310 to an observer 306. The comfort zone 308 shows the area in which objects need to be projected so they do not cause eye discomfort when viewed. FIG. 3 illustrates two different viewing configurations 300 and 302. In configuration 300, all objects are projected within the boundaries of the comfort zone 308, which results to comfort viewing of the three-dimensional image. However, in configuration 302, object 314 is projected outside and in front of the comfort zone 308, and the object 314 is projected outside and back of the comfort zone 308. Either of those two violations can cause eye strain, and it is best to correct three-dimensional images from such problems. This zone of viewing tolerance is defined by the limits of parallax that can be fused into a single image by the viewer, and will henceforth be referred to as the parallax budget. These limitations are addressed and compensated for by use of the presently disclosed subject matter.

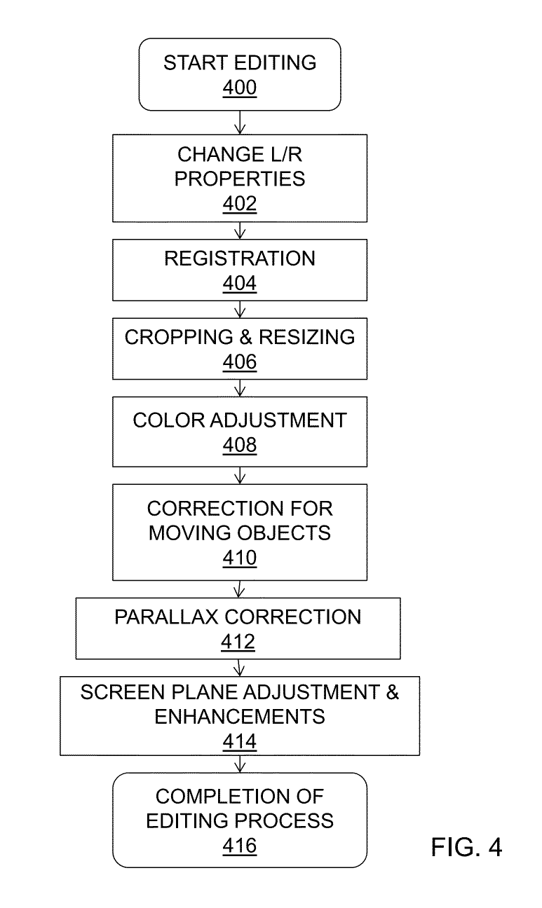

Elements of the present disclosure can be incorporated in a three-dimensional editing flow. For example, FIG. 4 illustrates a flow chart of an example method for three-dimensional editing in accordance with embodiments of the present disclosure. Referring to FIG. 4, this editing method can be implemented in any system that has a processor and a memory. For example, the method may be implemented in a personal or portable/mobile computer, a mobile computing device, a networked computing cloud device, or the like. Further, as an example, the method may be implemented by the image processor 124, or the system 100 and/or computer 106. The user interface at which the editing functions can be performed can be the same or a different computing device or any monitor that is connected to a computing device. The monitor can be a two-dimensional display or a three-dimensional display. In either case, the three-dimensional image to be edited can be displayed in any suitable formats, which include, but are not limited to, frame-sequential displays that can be viewed using active glasses, interleaved displays that can be viewed using passive glasses, anaglyph that can be viewed using color tinted glasses, autostereoscopic displays that do not requires any glasses, left/right images overlaid in top of each other on a standard display without glasses, or simply in side-by-side mode on a standard display with no glasses. It should be also noted, that the display method can change during the editing process. Possible viewing methods are left image only, right image only, or combined view of both right and left images in either a standard or a stereoscopic display mode.

The editing process described in this disclosure can be performed in different ways. First it can be implemented in a fully automated manner where the computing device receives the images and performs the corrections without any human intervention. It can be also implemented in a semi-automatic manner where a user interface enables interactions with a user to assist on the editing process. A user can outline the problem areas or can perform other functions that assist the correction process. Finally, the methods described in present disclosure can be implemented in a computer program whose steps and functions are driven by a user in a more manual manner. Under this scenario the user can select areas of image to be corrected, can chose the correction methods applied, and can chose the stereoscopic parameters to be applied. Automated methods can also be implemented under this scenario to supplement the manual functions and potentially apply automated methods to a part of an image and manual methods to other parts of the image. The user can utilize a mouse, a keyboard, or gestures in a touch-sensitive surface to define such operations.

Several other methods can be deployed to facilitate easy editing use of three-dimensional images. One example method is to quickly change display modes from three-dimensional, to two-dimensional and view left, right, or overlay of both the right and left images to determine the proper correction methodology. Factors such as what is behind the object or whether there are enough data to cover the occlusion zones that can be created by the movement of objects need to be accounted during this selection.

The method of FIG. 4 may start at step 400. The method may include changing left and right properties (step 402). For example, this step may involve changing the assignment of the three-dimensional image so the left image to become the right one, and the right image to become the left one. This change can correct the order at which the three-dimensional image has been captured, or sets the correct order for proper stereoscopic viewing in three-dimensional displays. Subsequently, the method includes a registration step 404 that can improve the alignment of the left and right images with respect to each other.

The method of FIG. 4 includes cropping and resizing (step 406). This step can set the proper framing. In case there are color differences between the left and right images, a color correction step 408 can be performed. If the three-dimensional image has been created by taking two pictures side-by-side using a single camera, there is a possibility that at least one object in the scene was moved during that time. The correction of moving objects process (step 410) can correct from such problems. In case the three-dimensional image has properties that violate safe viewing of the three-dimensional image, a parallax correction process (step 412) can be applied. Subsequently, screen plane adjustment as well as other image enhancements (step 414) can be applied to improve the overall viewing experience. Edits can be saved, and the editing process may end (step 416). It should be noted that those steps can be performed in different order. In addition, the steps can be executed in an automated manner or using manual assist from the user, as well as a combination thereof.

The correction processes described in FIG. 4 at steps 410 and 412 are shown in FIG. 4. The correction process can be applied in a fully automated manner for the entire image. It should be noted that any of the steps shown in FIG. 4 can be bypassed. If the fully automated process produces acceptable results, the editing process ends. If the results are not optimal, the user can discard all changes and invoke the manual correction mode or select only an area for manual editing that has not produced the desired results. The automated correction results can be rejected for the selected area, whereas the correction results for the non-corrected regions can be maintained. The selection process can also be accomplished in a reversed manner where the selected area keeps the automated results whereas the non-selected are the areas where corrections are rejected. Whereas correction is performed in either manual or automated manner, the editing process may be the same.

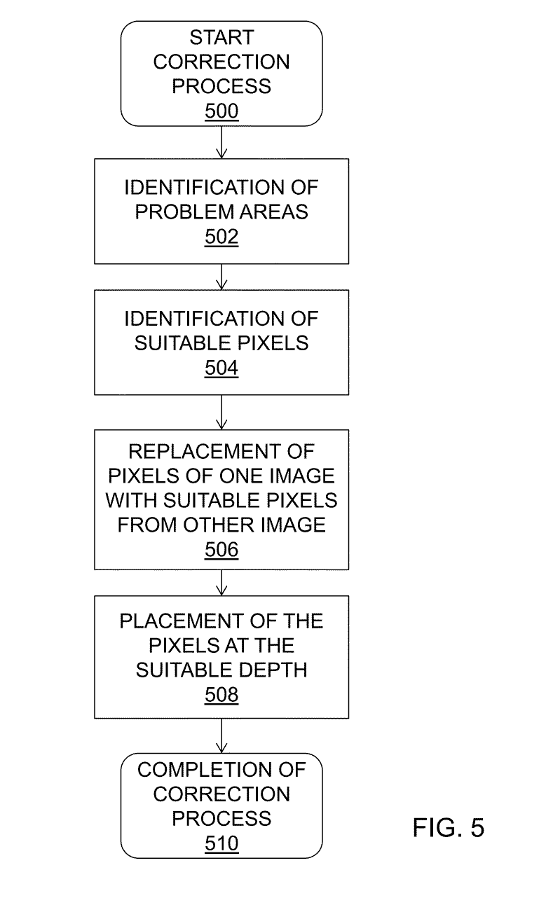

In accordance with embodiments, FIG. 5 illustrates a flow chart of an example method for correcting problems identified in a 3D image. Referring to FIG. 5, after initiation of the editing process 500, the identification of the problem areas (step 502) is executed. The method can be fully manual based on user observation, it can be fully automated, or a combination of both. In a fully automated or computer-assisted mode, the disparity between corresponding pixels from the left and right eye views of the three-dimensional image may be calculated. Areas where the disparities of groups of pixels are outside the viewing guidelines or where some metric M* (e.g., color difference, texture difference, gradient distribution, and the like) indicates weak pixel correspondence may be flagged for correction. Areas may be flagged due to object motion over the course of temporal sampling, improper stereo base during capture, occlusion, the like, or combinations thereof. The user can discard problem areas identified by the computer-assisted disparity calculation if image can be viewed comfortably in those areas. This can be particularly important since occluded areas do not warrant correction, and indeed may not be corrected for proper perception. Recognition of occlusion versus object motion is of particular import. FIG. 3 shows an example of an “unnatural” occlusion area that is due to object motion rather than viewing angle.

The method of FIG. 5 includes identifying problem areas (step 502). For example, an area may be identified from the left or right image to replace the corresponding area on the right or left image respectively (step 504). As an example, this step may include examining the identified problem area (pixel set K) in a given image, and the values of M* for pixels surrounding that area (pixel set P, K⊂P) that are indicative of a strong and correct correspondence. Given an identified pixel set, P, with high confidence of correct correspondence (indicated by M*), the disparity values of the set P may be estimated and/or interpolated to determine the prospective region of interest (pixel set C) in the “other” image. Further refinement may be performed by executing secondary matching measures to determine the best or improved alignment within a prospective region of interest. The pixels within the region C in the “other” image that correspond to the positions of pixels subset K can then be used to generate the replacement pixels for K in the target image. This process can be fully automated (if results are satisfactory), fully manual (if a user so desires), or a combination thereof with automated initial results and subsequent user refinements. It should be noted that this can be a multiple step process. An area of the left image can be identified for copying to the right image and an area of the right image can be identified to be copied on the left image. Once the proper areas have been identified, the pixels in one image are replaced by the pixels on the other image (step 506). Subsequently, a proper depth may be assigned to each pixel that has been replaced (step 508), and the correction may subsequently be completed (step 510).

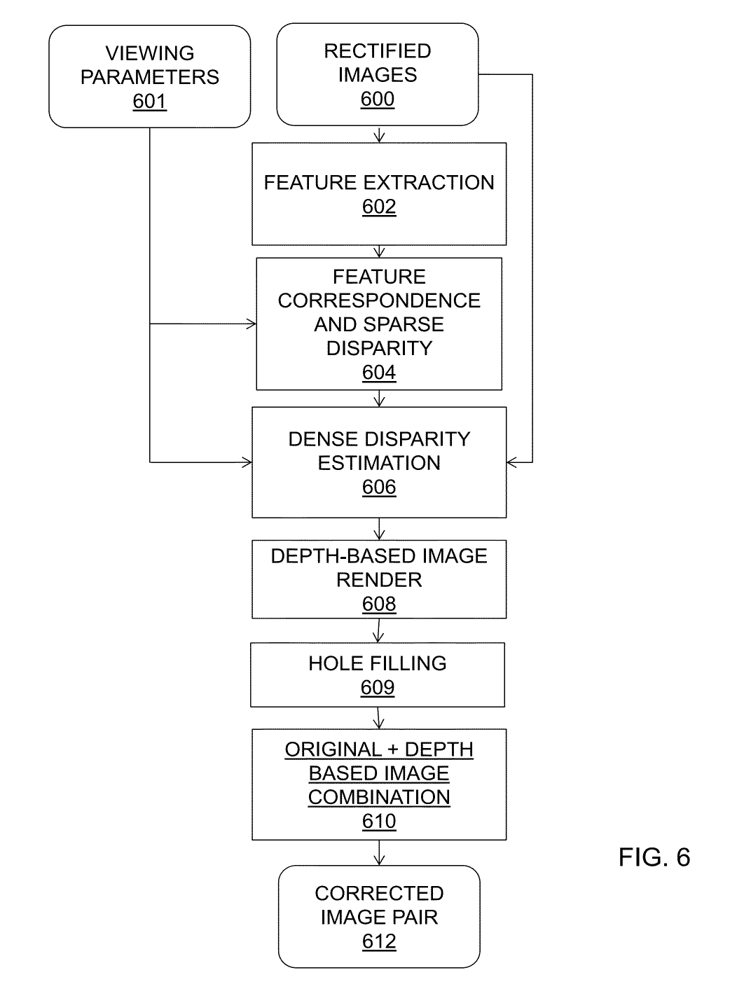

FIG. 6 illustrates a flow chart of an example method for automatically correcting problems identified attributed to moving objects or other three-dimensional viewing violations in accordance with embodiments of the present disclosure. A goal of automated correction is to produce an image pair that corrects for any object movement between the two image captures, and/or any significant violations of acceptable parallax budget. Automated correction can begin with a pair of rectified images (step 500) and a selection of viewing parameters (step 501) that can be used to determine comfortable disparity limits for a viewer. In practice, these viewing parameters can be whatever one desires in order to set a maximum disparity limit for searching, but in this example, the parameters may include, but are not limited to, expected viewing distance, horizontal resolution, and display width, such that a limit of disparity may be calculated as no more than 1.5 degrees of parallax and/or a diopter change of 0.25. The setting of this value can be what defines the acceptable parallax budget for the end result of this process.

The method of FIG. 6 includes feature extraction (step 602). For example, each image in the image pair may proceed to a stage of feature extraction, although the algorithm can be agnostic with regard to the method used. In an embodiment, images are first filtered for noise, and then features can be extracted using a suitable corner detection methodology using the values of multi-directional gradient operations applied to each image. While somewhat more complex than a similar application to simple intensity values, this methodology can empirically provide better localization of features, and subsequently better correlation. Moreover, this methodology can better allow for adaptive thresholding for feature identification since it is easier to identify peaks in the gradient distribution for a given region than it is in the intensity values.

The method of FIG. 6 includes correlating extracted features between images (step 604). For example, extracted features can be correlated between two images to create a sparse disparity map. Again, the gradient based features seem to provide a higher degree of correlation accuracy, although the correlation methodology is not limited to this embodiment. Correlated points can subsequently be reviewed to ensure an injective mapping of points for the sparse disparity matrix. While creation of a sparse matrix is highly beneficial, it is not necessary, and indeed, the subsequent steps of the algorithm can provide good results without it.

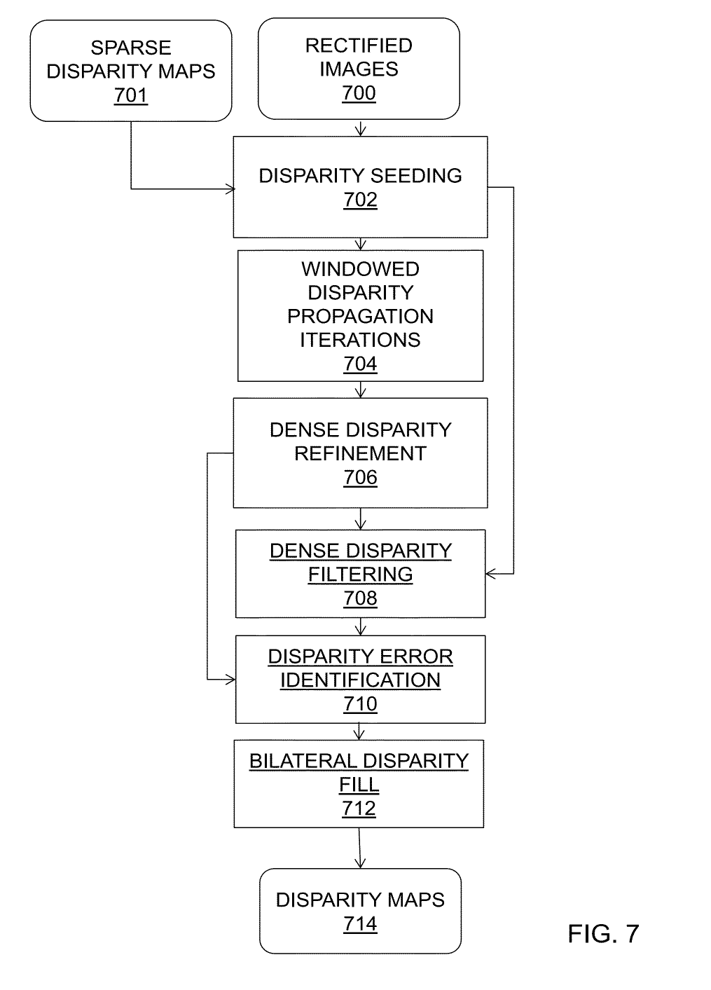

The method of FIG. 6 includes dense disparity estimation (step 606). This process is further detailed in the example of FIG. 7. This algorithm may be required to fulfill one or more of the following conditions: it must be reasonably precise, and highly accurate with minimal error, particularly on edge boundaries of objects, and particularly with regard to disparity distribution within objects; it must operate well in the presence of occlusion, possibly significant; it must operate well in the presence of objects that have changed position due to object movement between images, and further must provide a means to identify these image regions and create correct disparity for them; it must operate on large disparity ranges; and it must operate on a complete range of images such as might be encountered in every day image captures.

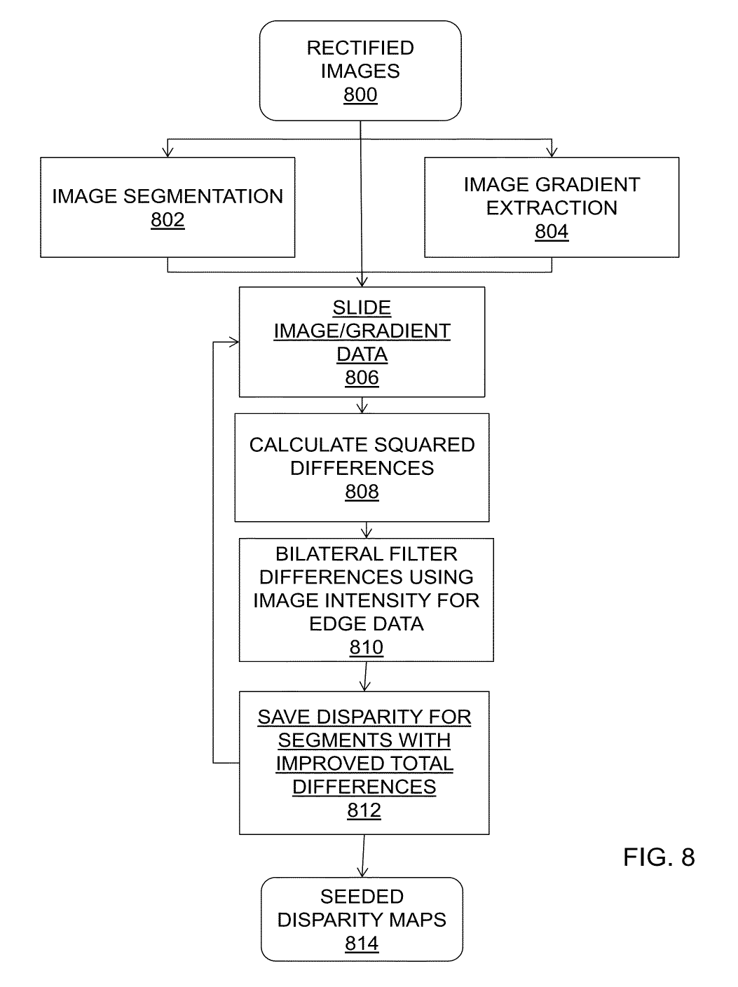

FIG. 7 is a flow chart of an example method for dense disparity estimation in accordance with embodiments of the present disclosure. Referring to FIG. 7, the method may begin with seeding of dense disparity values (step 702). Seeding may be random in the absence of a sparse map, or can be as simple as a set of sparse disparity values, or something more complex. An example of an embodiment of dense seeding is detailed in FIG. 8, which illustrates a flow chart of an example method for dense seeding in accordance with embodiments of the present disclosure.

Referring to FIG. 8, seeding utilizes a combination of color and multi-directional gradient information (step 804) extracted from the images, as well as a segmentation of the images (step 802). This method is agnostic about the image segmentation technique used. This embodiment uses a gradient calculation and thresholding, with subsequent comparison of the smoothed color difference between neighboring pixels versus their gradient levels to decide whether pixels should be included in the same segment or separated.

The gradient (step 804) information used throughout the algorithm extends beyond the typical horizontal/vertical, and instead includes additional gradient filters for the top-left to bottom-right diagonal and the top-right to bottom-left diagonal. These are viewed as requiring limited additional computational complexity while providing significant information in many cases. Seeding in this embodiment proceeds as follows: For the range of possible disparities D=(−MAX: MAX), the predicting image is “slid” 706 left/right by the current value of D pixels, replicating the first or last column as necessary. At each new position of D, a cost metric for each pixel is calculated, in this embodiment, the total mean square error for each of the color and/or gradient channels. In an embodiment, color and gradient information is weighted more highly than the luminance/intensity information. The pixel differences may then be filtered before being aggregated for final cost analysis. In this embodiment, the squared error values are bilateral filtered (step 810) using a resolution dependent region size and using the intensity (or green for RGB) image channel. Subsequently, for each labeled segment, the sum of filtered squared error values is calculated and a cost metric for the segment is calculated, with example cost metrics being the median, the mean, and the mean plus one standard deviation, which we have found to be the most accurate. Finally the disparity value for the pixels in the segment is only assigned to the current value of D if the cost metric value is better than the best cost for that segment up to that point in time (step 812). The process ends after D has traversed the range of values and results in a highly accurate, if regionally flat, disparity map for the image. It may be that this embodiment is only applied to produce a disparity map suitable for image generation for the purpose of stereo editing, as noted in the path directly from (steps 702-708). The seeding process is performed in both directions to produce a pair of seeded disparity maps, one predicting the left image using the right [henceforth the “left” disparity map], and the other the right image using the left [henceforth the “right” disparity map]).

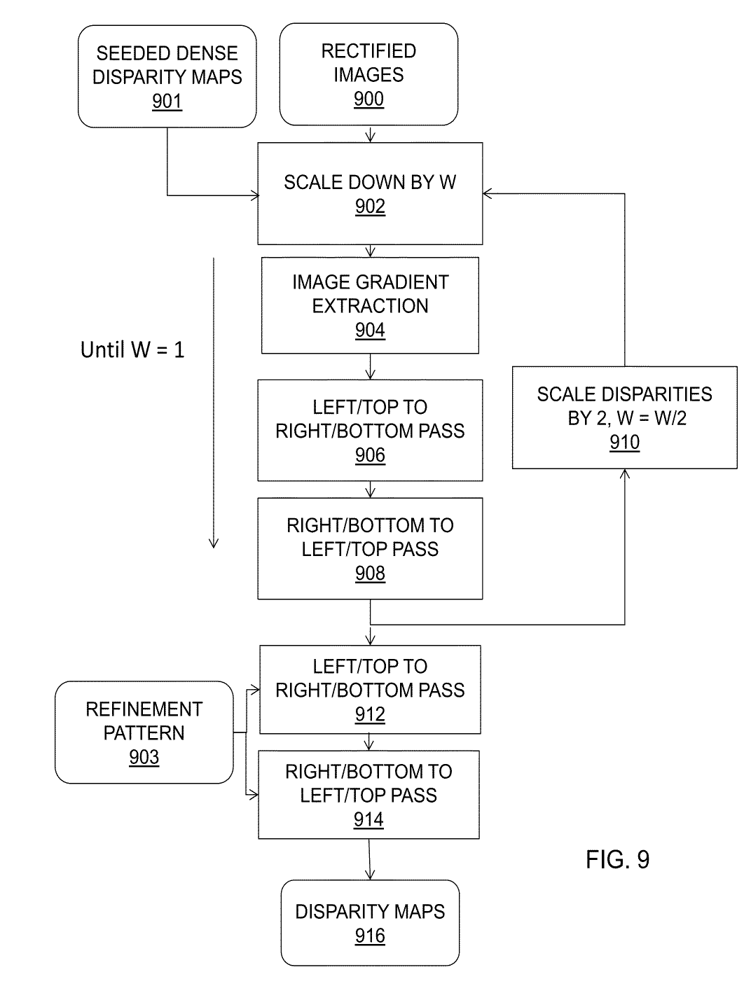

Referring again to step 7, after the seeding process is completed, pixel level dense disparity estimation (step 704) commences. Again it is noted that other embodiments of dense disparity estimation may be used, however one embodiment is detailed in FIG. 9. At a high level, the process involves multiple iterations of windowed matching using a specific matching cost function metric. The metric is applied to a pyramid of down-scaled versions of the images, beginning with the smallest and working to the largest, utilizing the seed values previously generated. At each new level, a scaled-up version of the prediction from the previous level is used as an initial guess of the pixel disparities.

In detail, the process begins by defining a “span” window for matching between the two images, and determining a “W” value, which is the largest scale down factor to be applied. Typically, W is set as 4 initially (a ¼ reduction of the images) for a trade-off of compute time versus accuracy, although a more optimal W can also be calculated using methods such as a percentage of the image resolution, a percentage of the span value, a percentage of the maximum absolute value of the seeded disparity maps, and the like.

The method may then iterate through steps 902-908. The images are scaled down by 1/W (step 902), their multi-directional image gradients are extracted (the same multi-directional gradient as detailed earlier) (step 804), and two “passes” of matching occur (steps 806 and 808). There are many ways to constitute passes, although in an embodiment, a forward pass constitutes examining each pixel from the upper left to the bottom right and testing potential new disparity values using various candidates. Examples of potential disparity candidates are listed below. It should be noted that other types of candidates and metrics can be added in the process or some of those described below can be removed from the process such as, but not limited to: the disparity of the pixel to the left of current (LC); the disparity of the pixel above current (AC); the value LC+1; the value LC−1; the current disparity value +1; the current disparity value −1; and the value of the seed input disparity map, which helps to “re-center” any areas that may have become errant due to large differences in the disparities within an aggregate window of pixels.

A cost metric utilizing characteristics or attributes, that may include disparity, of pixels in an area around the current pixel, is then calculated to determine its disparity. The best cost result of this set is identified and compared to the current best cost for the pixel being examined. If it is better than current based on a defined threshold X, the disparity value for the current pixel being examined is updated to the value of the examined pixel and the cost updated. Additionally, a discontinuity metric can be added to the comparisons, wherein the cost metric values of pixels that can become discontinuous by more than +/−1 relative to other neighbors require a greater percentage improvement.

The cost metric used in this embodiment utilizes Gaussian weighting based on the difference in color of the pixels in the window relative to the current pixel being examined. Two pixel windows from the left and right images, are presented to the cost calculation, and for each pixel, the following information is available: R channel value; G channel value; B channel value; and multidimensional gradient magnitude.

Numerous other pixel data sets can be analyzed, including but not limited to luminance plus gradient, luminance only, RGB only, RGB plus each dimension of gradient, luminance plus each dimension of gradient, and the like. Any cost function that utilizes characteristics and attributes of neighboring pixels in both left and right images can be used to determine whether the current pixel can be assigned with the disparity value of any of its neighbors or with a mathematical equation of them such as average, median, weighed average, and the like. Dependent on the specifics of the data set, the cost function operates on the same principle, which is to: calculate the maximum difference of the color (or luminance) channels of the pixels from the image to be predicted versus the pixel in that window that is currently being evaluated; calculate a Gaussian weight based on these differences and a value of sigma for the distribution; calculate the Sum of Squared Error (SSE) for each pixel, multiply the SSE values by the Gaussian weights; and divide by the sum of Gaussian weights (in effect, a weighted mean based on the color differences of the pixels around the current pixel being evaluated).

Mathematically, the process may be implemented as follows:

| | |
|---|---|
| 1. | Input windows L(1:n, 1:n, 1:4) and R(1:n 1:n, 1:4), and the pixel position in L currently being |
| | evaluated L(y, x, 1:4) |
| 2. | A = 1/sigma² |
| 3. | D = MAX_{channels 1:3}([L(1:n, 1:n, 1:3) − L(y, x, 1:3)]²) |
| 4. | $L = \frac{1}{A * D}$ |
| 5. | DIFF = Sum over channels([L(1:n, 1:n, 1:4) − R(1:n, 1:n, 1:4)]²) |
| 6. | COST = DIFF * L/sum(L(:)) |

The reverse pass (step 908) proceeds similarly, but from bottom to top, right to left. The same cases, or a subset, or a larger set may be tested (for example, possibly testing values “predicted” for the left map using the right map, or vice versa).

When the reverse pass is complete, the end resulting disparity map can optionally be bilaterally filtered using the color values of the scaled down input image as the “edge” data. W is divided by 2, disparities are scaled up by 2 and used as new seeds, and the process continues until a full pass has been done with W=1. The value of 2 is arbitrary, and different “step” sizes can be and have been used.

Following these operations, two additional “refinement” passes can be performed (steps 912 and 914). For a refinement pass, the span is dropped significantly, sigma may optionally be dropped to further emphasize color differences, and the cases tested are determined by a “refinement pattern” (step 903). In our embodiment, the refinement pattern is a small diamond search around each pixel, although the options can be more or less complicated (e.g., testing only the left/above pixel values or the right/below). The process exits with a pair of dense disparity maps (step 916).

Referring again to FIG. 7, following dense estimations, an optional filtering (step 708) can be performed on the disparity maps. Filtering may be done for the purposes of edge sharpness in the disparity map, general smoothing, segmented smoothing, and the like, with the filter definition differing commensurately.

Disparity “errors” are next identified (step 710). Errors may be indicative of occlusion, moving objects, parallax budget violations (either object or global) or general mismatch errors. Various methods may be used for these purposes, including left/right map comparisons, predicted image versus actual image pixel differences, and the like. In an embodiment of this process, three steps may be used. First left/right map comparisons are done (left prediction matches the inverse of the right prediction within a tolerance). Second, disparities within image segments are examined for statistical outliers about the median or mode of the segment. Finally, image segments with enough “errant” values are deemed completely errant. This last step is particularly important for automatic editor corrections because portions of a segment may be very close to being proper matches, but if not corrected as a full segment will produce artifacts in the end result. Image areas that are found to be errant in only one of the image pair are indicative of “natural” occlusion, while areas that are found to be errant in both images are indicative of moving objects, parallax budget violations, and/or general mismatch errors. Values in the disparity maps for these “errant areas” are marked as “unknown.”

The method of FIG. 7 includes bilateral disparity fill (step 712). This step may account for the filling of “unknown” areas, which can be accomplished in a number of ways. Examples might include interpolation using triangulation of “known” areas or estimation via image segment extrapolation. Step 712 may indicate an embodiment of this work, which is the use of bilateral filtering as a fill methodology. A smoothed disparity map is created by applying a bilateral filter to the current disparity map and using the image intensities of the target image (left image for the left disparity map, right image for the right disparity map). Each “hole” of unknown disparity value is filled using the smoothed “known” disparities around the targets as estimates. In short, pixels around the target pixel with “known” values of disparity are used to estimate the disparity of the target pixel with a weighting based on a combination of Euclidean distance in the image and intensity distance from the target pixel. This fill operation can be iterative if necessary, with the constraints on the sigma range and spatial values in the bilateral filter being lessened as necessary to accomplish a fill.

With dense disparity estimated, depth-based image rendering is applied to the “left” input image to generate a new “right” image estimate (step 608). This process can include projecting the pixels from the left image into a position in the right image, obeying depth values for pixels that project to the same spot (“deeper” pixels are occluded). Unlike more involved depth image rendering techniques, a simple pixel copy using pixel disparities produces very satisfactory results.

Following the image rendering, there are generally holes in the rendered image due to disocclusion, since areas occluded in one image cannot be properly rendered in the other regardless of the accuracy of disparity measures. Disocclusion may be caused by any of the following: _“Natural” Occlusions—areas seen in only one view cannot produced from the other; moving objects—mimics “natural” occlusion, but adds in the complication of possible disocclusion for the same object in both views. In one view, the object causes “natural” occlusion in that it blocks pixels behind it. But in the other view, it additionally may cause occlusion of pixels where it has improperly moved that must also be corrected once the object is repositioned; and necessity of moving objects to reduce parallax budget, which presents the same problems as moving objects.

To decide between the first condition and the latter two, the disparity maps can be compared to determine if disparities disagree in one image or both. If in one image, these are most indicative of natural occlusion, and these pixels are filled using the existing right, or target, image. If in both, it is more indicative of object movement or relocation, which necessitates fill using the left, or base, image. The filling process (step 609), can be implemented as follows: for a given “hole” of missing pixels, gradients of the pixels around the hole are examined and the strongest are chosen. The location of these pixels in the appropriate image (right image for occlusion, left for object movement or vice-versa), is calculated for filling purposes. The hole is subsequently filled with pixels from the appropriate image using pixels offset from that fill point. Other fill techniques may be used (means, depth interpolation, etc.), but for automated editing, this technique has proven to be the most successful, particularly for maintain object edges in the rendered image. The filling process can also utilize suitable concepts similar to the ones described in “Moving Gradients: A Path-Based Method for Plausible Image Interpolation” by D. Mahajan et al., Proceedings of ACM SIGGRAPH 2009, Vol. 28, Issue 3 (August 2009), the content of which is incorporated herein in its entirety.

The rendered and original images are finally combined to produce a final “edited” image (step 610). Combination can include identification (either automatic or by the used) of specific areas to use from the rendered image versus the original; comparison of color values between the rendered and original, and replacement of only those pixels with statistically significant color differences; depth comparisons of the original and rendered images and maintenance of the original wherever depth matches or occlusion was indicated, and the like. The final result of the process is a new image pair with automated correction for moving objects and/or violation of parallax budget constraints.

In the event of global parallax violations, it is possible that no portion of the original image may be used; and indeed, by changing the definition of the parallax budget input to the process, the correction flow can be used to create synthetic views that match a different stereo capture than that of the original. In this case, the disparity offsets of the pixels between the original images are suitably scaled, such as would match those of a lesser or greater stereo base capture. As a general flow, nothing changes from what has been described. It is only at the point of image rendering when a decision is made as to whether to scale the disparity values in this manner.

It should be also noted that this process can be applied selectively to one portion of the image using either automated or manually edited methods. During manual editing mode, the user can specify the area of the image where correction is to be applied. During automated method, processes that identify problems in the images, including but not limited to parallax budget and moving objects, can be used to identify such areas. The partial correction process can be executed in one of the following methods: correction process is applied to the entire image, and then chances are applied only to the defined correction area and all other changes are being discarded; and correction process is applied to a superset of the defined correction area and only the pixels of the defined correction area are replaced. In this case the superset should be sufficiently larger of the defined area to ensure proper execution of the defined methods.

Although this process can happen automatically, it is possible that the results of the automatic correction may not be acceptable. The present disclosure describes methods for performing this manually or semi-automatic. The manual correction process involves selection of region points in the image that define a segment of an image from either the left or right image or both when left and right images are overlaid in top of each other. Those region points define an area, and all pixels enclosed in that area are consider as part of the same object to which correction will be applied. Each pixel on the stereoscopic three dimensional images has a property referred to as disparity that represents on how far apart is one pixel with the corresponding pixel in the other image. Disparity is a measure of depth and pixels with zero disparity are projected on the screen plane of the image, whereas pixels with non-zero disparity appear in front or behind the screen plane, thus giving the perception of depth. In an area with problems, we have a collection of pixels has disparity values that violate certain criteria that determine comfortable stereoscopic viewing. The correction process involves the following: Use pixels from right image and place them at the proper depth at the left image and/or use pixels from the left image and place them at the proper depth at the right image.

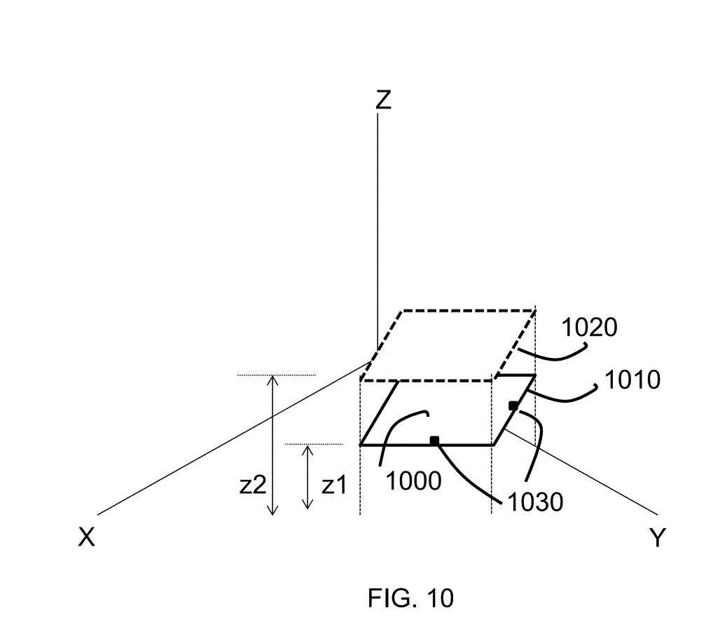

A first and simplest type of correction that is shown in FIG. 10, which illustrates a technique for correcting an area using a rectangular shape in accordance with embodiments of the present disclosure. This considers that all pixels in the defined region have the same disparity (they all lay at the same depth). Referring to FIG. 10, a flat surface 1000 is shown in depth location 1010 (z1). The user can manually set the depth of that area to location 1020 (depth z2). In addition, the user has the ability to control the size of the rectangle by moving the anchor points 1030 as well as to move it. The user can utilize a mouse, a keyboard, or gestures in a touch-sensitive surface to define such operations.

It is also possible to automatically assign the depth of the manually defined area by looking at the disparities of the areas that are outside the boundaries of the defined area. The disparity of the defined area can be calculated using the average disparity values of the adjacent to the defined area pixels.

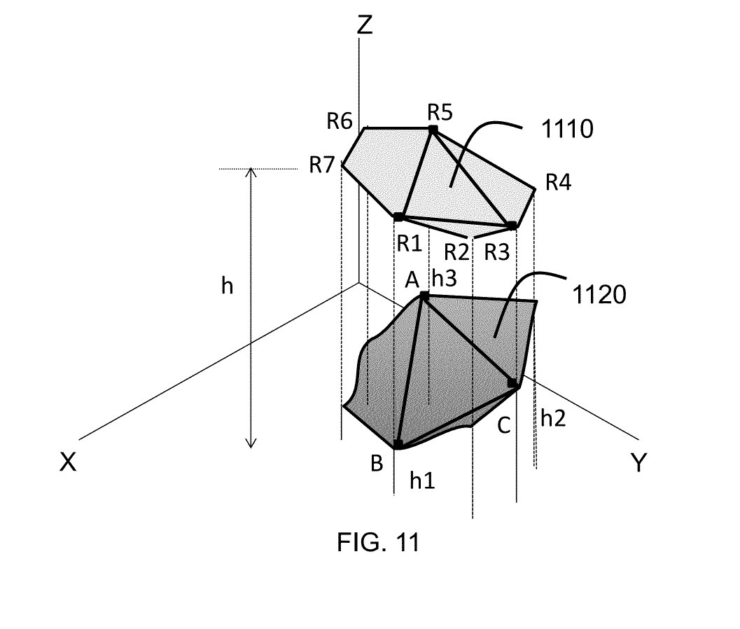

In case, the area is not at the same depth, a different approach can be deployed. An image area can be defined using a set of region points (R1 through R7) as shown in FIG. 11, which illustrates a technique for correcting an area using an arbitrary shape in accordance with embodiments of the present disclosure. Initially, this area can be parallel to the XY plane at location 1110 that has depth “h”. Any flat area can be defined by three region points that will be referred to as depth points A, B, C. In FIG. 11, depth point A is assigned to region point R5, B to R1, and C to R3. The process of placing an area flat area at different depths is accomplished by placing the depth points A, B, C at the desired depth by changing their respective disparity values. In FIG. 11, A is assigned with a depth of “h3”, B with depth of “h1”, and C with depth of “h2”.

The disparity of the depth points can be also calculated automatically using the average disparity value of a collection of pixels that are adjacent to the corresponding depth point and reside outside the boundaries of the defined region. Another semi-automatic method for assigning disparity to a depth point is to extract interesting/key points that are close to the depth point, calculate the disparity map of those key points and have the user to select one of the key points to assign a disparity to the depth point.

After disparity has been assigned to the depth points, all other remaining pixels on the defined area are computed by linearly interpolating the disparity values of depth points. It should be noted also noted that the interpolation and disparity value assignment of every pixel can take a subpixel values. After disparity has been assigned to all pixels on the defined area, the proper pixels are copied from the left image to the right image, or vice versa. It should be also noted that correction can be accomplished by using pixels from the left image to replace pixels on the right image and pixels from the right image to replace pixels on the left image. This has an effect of taking a collection of pixels forming a region from one image, copying them to the other image, and adjusting their depth value. Using this methodology we can correct from problems arising from moving objects as well as high parallax.

Although the described process works well for objects that consist of pixels that are at the same plane, there is need to perform similar functions to objects that have pixels that are not on the same plane. An example can be a tree that or any other three dimensional feature. In this case, the pixels need to have different disparity values that cannot be computed using linear interpolation methods. The disparity of the region points can be set manually, or it can be calculated automatically using the disparity average of the adjacent pixels as was disclosed earlier. The disparity of the other pixels in the region is then calculated using three-dimensional curve fitting methods based on the disparity of the region points.

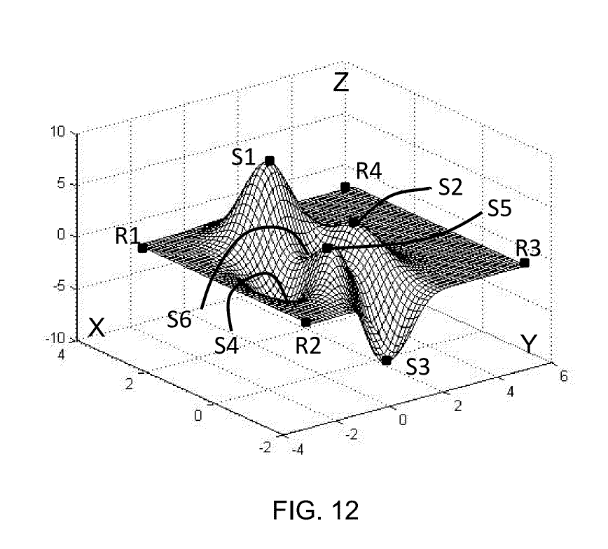

Furthermore, it may be desirable to represent parts of the object at different depths. An example of such surface is shown in FIG. 11, which illustrates a diagram of a technique for correcting an area using an arbitrary shape in accordance with embodiments of the present disclosure. An arbitrary flat surface can be first defined using region points as was described earlier. In FIG. 12, an arbitrary area has been defined using region points R1 through R4. Then a set of surface points can be defined manually at various areas of the defined area (S1 through S6). The disparity of those surface points can be then defined manually. S1, S2, S5, and S6 points have been assigned with a different positive disparity, whereas points S3 and S4 have been assigned with negative disparity. Disparity on all other pixels in the defined area is then calculated using three-dimensional curve fitting methods based on the disparity of the region and surface points.

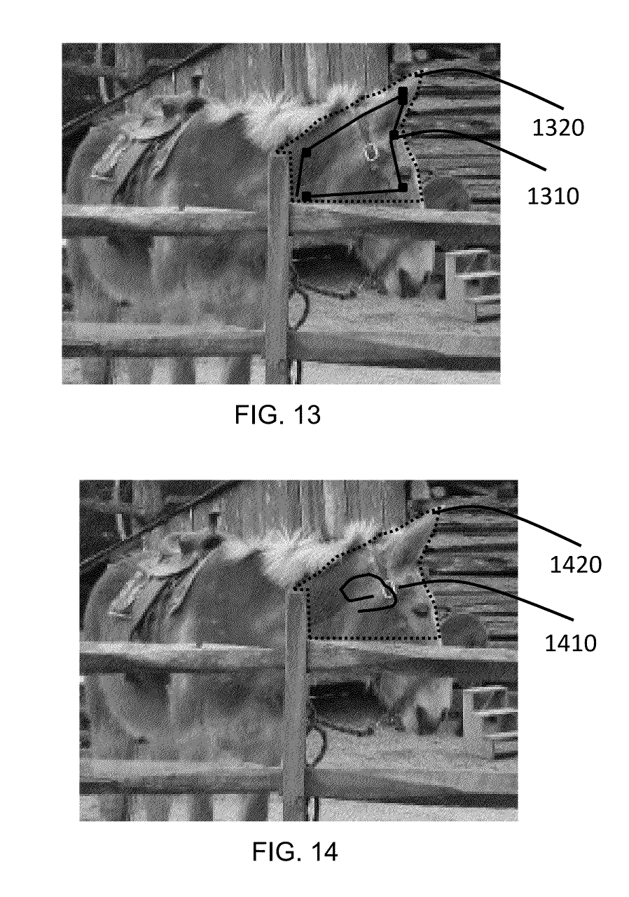

Once the problem area has been identified, the user can select this area using one of the following methods:
Rectangle area selection: User defines a rectangle area with a center that is placed in top of the area with problem (FIG. 10)
Arbitrary area selection: User defines a set of points that fully encloses the target area (FIG. 11). The user can have also the ability to move the location of the points, delete points, or insert new points to better define the target area
Area outlining with image processing augmentation (FIG. 13): User defines a set of points 1210 that outline the target area and then with image processing techniques the outline is expanded to include all pixels of the object up to its boundary 1320.
Object selection (FIG. 14): User defines a scribble or a dot 1410 in an area and image processing techniques are used to fully define the boundary of that object 1420.
   During the copying process, the exposure and white-balance of the selected pixels can be corrected to match the ones in the target image.

There are a significant number of digital cameras that can perform fast burst, or multi-capture, operations, where high-resolution images are taken at very short time intervals; at the order of several images per second. In a typical three-dimensional image creation process, two images, taken from two different positions, are required to create a three-dimensional image. One of the techniques that can be employed is to use the same camera to take two different images at different positions at different times. In this embodiment, a method is provided where the multi-capture capability found in existing cameras, can be used to take multiple shots between the target left and right positions to improve three-dimensional image quality when dealing with moving objects or parallax budget excess. Although the same techniques that were described in the automatic process can be used here and applied to all or a subset of the captured images to improve quality, additional information calculated from the movement of the camera and the images captured can be used to further increase the quality of the generated three-dimensional image.

For the fully automated process that was described earlier, the process can be applied to any combination of the capture images to create multiple stereoscopic images. In this case, the image combination step 610 described in FIG. 6 can be modified to include multiple images. The image pairs that had the better stereoscopic characteristics can generate the better stereoscopic images. Such characteristics may include the amount of moving objects between the two images, the stereo base between the two images, the color differences between the two images, and the like. It should be noted that the stereoscopic images created by this process can be further processed to create a synthetic view that combines segments from different images that have optimal three-dimensional characteristics to create a stereoscopic image with optimal characteristics.

In addition, capturing of multiple images at very close timeframes can be used to better identify moving objects that can assist on the identification of problem areas later on. Since two successive images during burst multi-capture will usually depict almost the same scene, the motion vectors (i.e., displacement of pixels between two successive images) can be different for static and moving objects. If, for example, a camera moves a total distance D between the first and last shot during time T, and N shots are taken during that time, there will be an approximate time interval of t=T/N between shots for a displacement of d=D/N. It should be noted that multiple images do not have to be taken at equal intervals. Utilizing this process and by performing motion image compensation between captured images, we can differentiate between moving and static objects provided that the speed of the camera movement is different compared to the speed of the moving objects. Since the instantaneous camera speed between successive s=d/t shots is very likely that it will change, it may be highly unlikely that the speed of a moving object will match the all the instantaneous speeds of the camera movement. This can provide a very effective method to identify moving objects. Pixels belonging to moving objects will exhibit different instantaneous speeds compared to pixels belonging to static objects.

The term “Instantaneous Differential Speed” may refer to the sum of all differences in speed between the static pixels (due to the move of the camera) and the speed of pixels in moving objects. In addition, it is possible that the two first shots can be taken in the initial position to easily differentiate between moving and static objects.

A three-dimensional image can then be created using one of the following methods:
1. Identify a suitable pair of images that have the smallest Instantaneous Differential Speed and create a three dimensional image using this pair
2. Identify areas with an Instantaneous Differential Speed higher to a pre-determined threshold and flag them as problem areas to be fixed with methods described in the automated correction process
3. Identify areas with an Instantaneous Differential Speed higher to a pre-determined threshold and flag them as problem areas, and select an image L representing the left view, an image R representing the right view and a suitable set of images M with the smallest Instantaneous Differential Speeds in the flagged areas. A synthetic R′ image will then be generated by combining the areas with areas with smallest Instantaneous Differential Speeds from the R as well as all other M views. A stereoscopic image will then be generated using the L and R′ images. It should be noted that the order of L and R can be reversed.

There are also cases in a scene where the movement of objects is obeying repetitive, semi-repetitive, or predictable patterns during the capturing of the two images. Examples include natural movements of humans or animals, movement of leaves and trees due to wind, water and sea patterns, racing, people or animals running, and the like. Also, there can be special cases where in an object different parts have different moving patterns. Such as example is the wheels of a moving car where the wheel are moving at different speeds and patterns compared to the car body. For instance, a car is “easy” to relocate because it's a solid object, but its wheels are not, because they are revolving. Utilizing the burst multi-capture capability we can predict the movement of such objects utilizing their instantaneous speeds and determined their appropriate matching poses to place them at the right location on the depth plane. The increase or decrease of an object in size between successive frames can be used to determine their relative position in depth at any given time thus creating a very effective model for determining its depth at a given time. In addition, multi-capture can assist on the hole filling process in action scenes since there are multiple shots that have been used to identify data to fill the holes on the target pair of images.

The various techniques described herein may be implemented with hardware or software or, where appropriate, with a combination of both. Thus, the methods and apparatus of the disclosed embodiments, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the presently disclosed subject matter. In the case of program code execution on programmable computers, the computer will generally include a processor, a storage medium readable by the processor (including volatile and non-volatile memory and/or storage elements), at least one input device and at least one output device. One or more programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

The described methods and apparatus may also be embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, the machine becomes an apparatus for practicing the presently disclosed subject matter. When implemented on a general-purpose processor, the program code combines with the processor to provide a unique apparatus that operates to perform the processing of the presently disclosed subject matter.

While the embodiments have been described in connection with the preferred embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed:

1. A method for modifying one of a left and right image for creating a stereoscopic three-dimensional (3D) image, the method comprising:
at a computing device including at least one processor and memory:
calculating disparity of the 3D image;
identifying areas including one or more pixels of the 3D image that violate pre-defined disparity criterion attributed to one of movement of objects between times the left and right images were captured, and the depth profile of the scene with respect to the stereo base at which the left and right images were captured;
identifying a region that includes pixels whose disparity exceeds a predetermined threshold;
identifying at least one key pixel in a corresponding area in one of the images to determine disparity attributes of the identified region;
identifying a proper depth of key pixels;
calculating the disparity of all remaining pixels in the identified area based on the disparity values of key pixels; and
utilizing disparity information to replace a pixel with a one of a corresponding pixel and a calculated pixel from a set of corresponding pixels.

2. The method of claim 1, further comprising receiving user input that defines the identified region.

3. The method of claim 2, further comprising receiving user input including information for adjusting the depth of the identified area.

4. The method of claim 2, further comprising automatically determining the depth of the identified area.

5. The method of claim 2, wherein the identified area is a rectangle.

6. The method of claim 2, further comprising receiving user input that selects an arbitrary shaped area by selecting points in the image to define such area and outline of such is generated automatically utilizing the selected points.

7. The method of claim 2, further comprising:
receiving user input that defines an in-liner of a target object; and
applying image processing techniques to augment the identified region defined by the in-liner to the boundaries of target object.

8. The method of claim 2, further comprising:
receiving user input that selects a point in an object; and
applying image processing techniques to select the entire object.

9. The method of claim 2, further comprising receiving user input to define a plurality of points in the identified region.

10. The method of claim 9, further comprising receiving user input to independently define depth of the defined points.

11. The method of claim 10, further comprising extrapolating the depth of each pixel in the select area by use of the defined depth of the selected points.

12. The method of claim 1, further comprising performing a registration step to assist in calculating the disparity map of the 3D image.

13. The method of claim 1, further comprising color correcting the selected pixels to match the pixels on the target image.

14. The method of claim 1, further comprising one of cropping and scaling the 3D image.

15. The method of claim 1, further comprising altering assignment of left and right images to match properties of one of:
image capture devices that captured the left and right images; and
a stereoscopic display.

16. The method of claim 1, wherein the depth budget of the resulting image is modifiable using Depth-Based Rendering techniques.

17. The method of claim 1, further comprising modifying stereoscopic parameters of the 3D image for improving quality.

18. The method of claim 1, further comprising applying feature extraction techniques to calculate one of correspondence and disparity.

20. The method of claim 1, further comprising calculating a sparse disparity map utilizing correspondence of extracted features.

21. The method of claim 1, further comprising calculating a dense disparity map.

22. The method of claim 21, further comprising a seeding by utilizing dense disparity values.

23. The method of claim 22, further comprising applying one of image segmentation and multi-dimensional gradient information to identify pixels that belong to the same object.

24. The method of claim 22, further comprising sliding the one of images on top of the other one, and calculating a metric at each position.

25. The method of claim 24, further comprising filtering the calculated metrics.

26. The method of claim 22, further comprising calculating the disparity value of an image segment.

27. The method of claim 21, further comprising applying a multi-level windowing matching technique to scaled image for improving disparity accuracy.

28. The method of claim 21, further comprising filtering the calculated disparity values.

29. The method of claim 21, further comprising identifying disparity errors that represent unknown disparity areas.

30. The method of claim 21, further comprising filling pixels with unknown disparity areas by pixels with known disparity values.

31. The method of claim 1, further comprising performing a depth-based rendering operation.

32. The method of claim 1, further comprising identifying pixels with unknown disparities that are a result of moving objects, and replacing the identified pixels with other pixels interpolated from pixels with known disparities.

33. The method of claim 1, further comprising performing image segmentation to identify pixels that belong to the same same object.

34. The method in claim 1, further comprising utilizing multiple images that have captured the same scene at slightly different positions to identify a suitable pair of image.

35. The method in claim 1, further comprising utilizing multiple images that have captured the same scene at slightly different positions to identify one of characteristics and attributes of moving objects.

36. The method in claim 1, further comprising utilizing multiple images that have captured the same scene at slightly different positions to identify areas to fill missing pixels from the target stereoscopic pair.

37. A method for identifying one of a left and right image for creating a stereoscopic three-dimensional (3D) image, the method comprising:
at a computing device including at least one processor and memory:
capturing a plurality of images of the same scene at slightly different positions;
calculating disparity information of the captured images;
selecting a pair of images whose disparity values are closer to a predetermined threshold; and
creating a stereoscopic pair using the selected pair.

38. A method for modifying one of a left and right image for creating a stereoscopic three-dimensional (3D) image, the method comprising:
at a computing device including at least one processor and memory:
capturing a plurality of images of the same scene at slightly different positions;
calculating disparity information of the captured images; and
utilizing pixels with known disparity values to replace pixels with unknown disparity values that are a result of moving objects.
